(19) United States
(12) Patent Application Publication
(10) Pub. No.: US 2021/0213489 A1
(43) Pub. Date: Jul. 15, 2021

(54) PIPE SHAVER

(71) Applicant: Willie Davis, Brooklyn, NY (US)

(72) Inventor: Willie Davis, Brooklyn, NY (US)

(21) Appl. No.: 16/742,728

(22) Filed: Jan. 14, 2020

(51) Int. Cl. B08B 9/02; A46B 13/02; B08B 1/04; B08B 9/023; A46B 13/00; B24B 29/00

(52) U.S. Cl. CPC B08B 9/021; A46B 13/02; B08B 1/04; B08B 9/023; A46B 2200/3093; B24B 29/005; A46B 2200/3013; B08B 2209/02; A46B 13/001

(57) ABSTRACT

A portable tool for simultaneously shaving, scraping or cleaning the outer circumference of pipe has a drill shaft that connects the tool to a power source. The drill shaft has a gear wheel attached to an inner end. This drift shaft engages a circular ban to form a gear assembly that will enable the ban to rotate when power is applied to the drill shaft. Connected to the inner wall of the circular ban is a plurality of bristles that will engage the surface of a pipe. After a pipe is inserted into the tool and power applied to the tool the drill shaft and circular ban will begin to rotate. As the ban rotates, the bristles will move over the surface of the pipe thereby performing the cleaning activity on the pipe's outer surface. During the cleaning process, the user can move the pipe linearly through the tool and clean the entire length of the pipe.

### FIELD OF THE INVENTION

This invention relates to a device, system and method for cleaning a pipe object. In particular, this invention relates to a new device that can simultaneously scrape, clean and smooth the entire external surface of a pipe object. This invention further relates to a pipe scraping and cleaning device that is attachable to a power tool.

### BACKGROUND

A pipe is a tube of metal, plastic, paper or other material. For centuries, civilization has used pipes as a means to transport various materials that may be liquids, gas or solids from one location to another location. From vehicles to homes to industrial plants and manufacturing facilities, pipes are an essential element that enables products and facilities to function. Because of the extensive use of pipe objects in our society, pipe products come in various sizes, lengths, diameters, and materials. In additions, the countless applications for pipes can create the need to modify a pipe for a particular application.

One process to modify a pipe is to shave the pipe. Many products and tools are available to modify a pipe as needed. Scraping pipes involve scraping the surface of the pipe to remove rust or other rough material in order to smooth or polish the surface. In some instances, one may shave a pipe surface. In this process, the intent is to reduce the outer diameter of the pipe surface for a particular application. As part of incorporating pipes into various products and applications, it is sometimes necessary to cut, shave, scrape, weld, clean or fit pipes.

The development of products for modifying a pipe object for various applications has evolved over time. U.S. Pat. No. 3,895,463 describes an apparatus for the buffing and polishing of metal tubing, such as steel, aluminum, brass and like metal tubing, either as the metal tubing is fed continuously from the tubing machine or tube mill or for buffing and polishing so-called off-line tubing of finite lengths. The apparatus buffs and polishes the entire outer surface of the tubing which may be cylindrical, square, or other shape, in cross sectional form.

U.S. Pat. No. 4,744,123 describes a device for shaving material from the outer surface of a pipe. This design includes a chuck for securing the device to the end of the pipe, a drive shaft having its axis coincident with the pipe axis and a fixed plate immovably secured to the drive shaft perpendicular thereto. A cutting unit for scraping the outer surface of the pipe is secured to an arm, which extends parallel to the drive shaft, and the arm is secured to a disc that is movably secured to the fixed plate, thus permitting radial adjustment of the cutting unit.

U.S. Pat. No. 6,698,321 describes a pipe shaver a pipe shaver for removing a uniform layer of material from the outer diameter of a pipe, the pipe shaving includes a housing including a longitudinal axis; a cutting blade including a blade guide for positioning a front face of said cutting blade at an angle theta of not less than 95 degrees relative to the pipe surface and for mounting said blade to said housing, said blade including a cutting edge; a lifting means for manually urging said blade radially outwardly away from said pipe and inwardly to the outer diameter of the pipe; and a lever for manually urging said blade radially outwardly away from said pipe and a threaded cam for moving said cutting edge longitudinally along the outer diameter of said pipe for shaving a thin substantially uniform layer of material off the outer diameter of the pipe.

U.S. Pat. No. 7,413,505 the present invention relates to a hand-held motorized device that is designed for sanding cylindrical objects. The invention comprises a left side and right side within which are a plurality of rollers, a motor, an on/off button, power supply, and sanding belt. A plurality of diameter knobs located on the exterior side of the housing enable a range of adjustment for various diameters. The sides can be disassembled to enable sanding belt replacement. The device has appealing uses comprising sanding down copper ends for soldering during plumbing installation.

U.S. Pat. No. 6,813,797 the invention is an adjustable wire brush tool for cleaning either the inside or the outside end of a copper pipe or fitting in preparation for soldering the parts together. The tool includes a hollow cylindrical section with a first wire brush on the interior surface of the section. Attached at one end of the cylindrical section is a slightly smaller cylindrical section sized to hold a second cylindrical twisted steel brush having a hexagonal shaft that extends from the smaller section, opposite the larger cylindrical section. The twisted steel brush and attached shaft can be moved to extend the twisted brush beyond the open end of the larger cylindrical section, for insertion into a fitting to clean the fitting interior surface by attaching a power drill to the shaft and rotating the twisted steel brush attached thereto. To clean the outside of a pipe, the twist brush is retracted into the smaller section and secured to that section with an engaging means. The pipe is inserted into the larger section, and the drill is activated to rotate the shaft and attached larger section to clean the pipe outer surface. The tool overcomes the need for separate tools to perform each task and requires but one drill to perform either task as needed. The tool is sized to handle a particular diameter of pipe and fitting, with sizes ranging from one-quarter inch to several inches.

U.S. Pat. No. 5,038,525 describes a pipe end polishing apparatus and method which comprises a cradle having an open section and a pair of pivotal doors covering the open sections and adapted to move between an open, pipe receiving position and a closed, pipe polishing position, the doors biased to remain in an open, pipe receiving position. The doors and the cradle contain a resilient material on the inner surface to retain a pipe to be polished in the pipe polishing position. An endless belt is adapted to be placed about the exterior surface of the cradle and over the doors surface in the open, pipe receiving position and in the closed, polishing position to surround the end of the pipe to be polished. The method comprises placing a pipe to be polished in the pipe receiving position and moving the pipe radially downward so that the doors snap into a pipe polishing position, rotating the cradle, preferably by a power hand drill, to polish the pipe end and removing the pipe axially from the one end of the cradle to permit the doors to move again to the pipe receiving position for the next pipe to be polished.

U. S. Patent Application 20010014577 describes a hand-held belt sander has a housing, an on-off switch and a power supply conductor supported by the housing, a motor and a transmission received in the housing, a sanding belt, a driving roller driven by the motor and driving the sanding belt, a sliding shoe provided with a base, a deviating roller arranged so that said sanding belt is guidable over the deviating roller and the base of the sliding shoe, a unit for centering the sanding belt, a unit for clamping the sanding belt, the deviating roller and the driving rollers have different diameters so that the sanding belt is guided inclinedly, the housing being elongated and the sanding belt being guided on guiding parts which are introduced in a rear region of the elongated housing so that with together with the sanding belt in a front region of the elongated housing a centrally forwardly extending, freely projecting, wedge tip-shaped contour is formed so that the hand-held belt sander as a whole has a lance-like contour.

The products in the above-listed publications describe products that modify the surface of the pipe product. However, the pipe surface is circular and these devices work on one portion of the surface at a time. As a result, producing a uniform shaving, scraping or smoothing of the pipe surface is more challenging. U.S. Pat. No. 9,021,926 to Bortoli describes a multiple tool device, particularly adapted to prepare tubular elements to be welded by electrofusion, comprising a cup member which is associable with the end portion of a tubular element and is provided with motion transmission means adapted to turn the multiple tool device. The particularity of the present invention resides in that it comprises scraper means adapted to remove the outer surface layer of the end portion and facing means which have a working motion that is opposite with respect to the preceding means and are adapted to face the edge of the end portion so as to make it perpendicular to the axis of the tubular element.

Although the patent to Bortoli provides for a circular scraping of the external surface of a pipe, this product only conditions the end portion of the pipe to prepare the pipe for welding. There remains a need for a product that can uniformly and simultaneously scrape the full length of the outer surface of a pipe without being limited to the end portion of the pipe.

### SUMMARY

It is an object of the present invention to provide a portable hand-held tool capable of scraping, shaving, smoothing or cleaning the external surface of a pipe.

It is a second object of the present invention to provide a tool capable of scraping, shaving, smoothing or cleaning the external surface of a pipe that can connect to and be powered by an external power source or internal power source.

It is a third objective of the present invention to provide a tool that can simultaneously be applied to 360 degrees of a pipe's external surface.

The present invention provides a portable tool that one can use to clean or modify the external surface of a pipe. This tool provides advantages over other tools in that this tool enables a user to work on the entire surface of the pipe without the need to reposition the pipe during the process.

The tool of the present invention can comprise a drill shaft that connects the tool to an external or internal power source. This shaft also connects to a gear assembly, which drives a circular ban causing the ban to rotate. Bristles attached to the inner surface wall of the ban are in contact with the external surface of the pipe. As the ban rotates, the bristles move across the surface of the pipe causing the bristles to scrape the external surface of the pipe, which results in the removal of unwanted material from the pipe surface. During this process, one can move the pipe through the ban and bristles as desired to clean to pipe. The ability to move the entire length of the pipe through the bristles enables one to clean pipe without the need to secure the pipe to a stationary object prior to the start of the cleaning process. Preferably, the present invention also has a housing cover to secure and stabilize the gear assembly and bristle ban during the pipe cleaning process.

### DESCRIPTION OF THE DRAWINGS

FIG. 1 is a side view of the pipe-cleaning tool of the present invention.

FIG. 2 is a view of the pipe-cleaning tool of the present invention looking up from the bottom side of the tool.

FIG. 3 is a top-down view of the pipe-cleaning tool of the present invention showing the tool in position to receive a pipe for cleaning.

FIG. 4 is a top and front view of the pipe-cleaning tool of the present invention in position to receive a pipe for cleaning.

FIG. 5 is a top and side view of the pipe-cleaning tool of the present invention in a closed position after receiving a pipe for cleaning.

FIG. 6 is a flow diagram of the general steps in the process of shaving, scraping or cleaning a pipe object in accordance with the present invention.

### DETAILED DESCRIPTION OF THE INVENTION

The present invention provides a tool for cleaning the external surface of a pipe object by techniques that include scraping, shaving or smoothing the external surface of the pipe. This invention enables a user to perform this cleaning tack without the need to mount the pipe in some type of stationary device prior to initiation of the pipe cleaning activity. This present invention also enables a user to clean the entire pipe without the need to remount or reposition the pipe during the cleaning process in order to efficiently reach various portions of the pipe. The present invention provides simultaneous contact with the entire surface of the pipe. Other tools and methods for cleaning or shaving a pipe supply a blade that rotates around the pipe surface but the contact of the blade with the pipe surface is not uniform and simultaneous.

The concept of the present invention comprises a basic component of a drill shaft attachment. This drill shaft connects on one end to a power source such as a power drill. The other end of the drill shaft attaches to a ban and forms a gear assembly with the ban. The ban can have an outer surface in the formation of a gear that interacts with the drill shaft to cause the ban to rotate in a circular motion. Bristles are attached to the inner surface of the ban. The bristles are in contact the outer surface of a pipe that the user wants to clean, scrape or shave. When the power drill rotates the drill shaft, this motion will cause the ban to rotate. As the bristles, which are in contact with the outer surface of the rotate, the bristles will scrape the outer surface of the pipe.

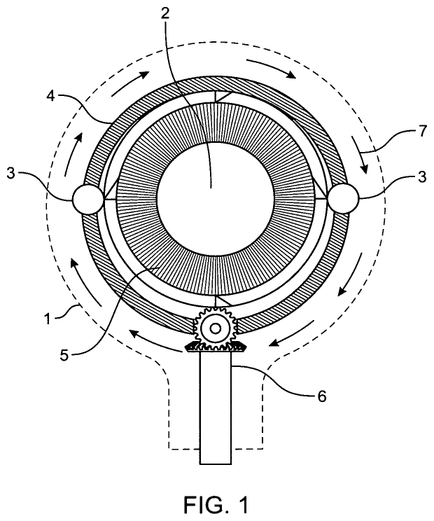

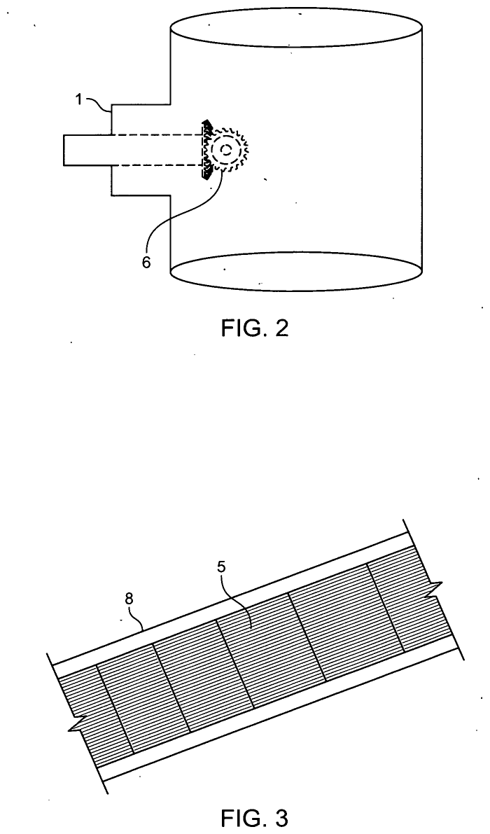

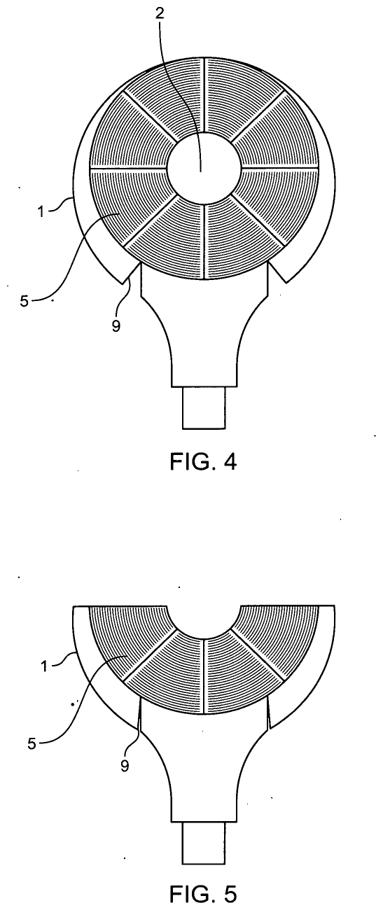

FIG. 1 shows the implementation of the concept of the present invention. A drill attachment shaft 100 has one end that attaches to a power source such as a power drill. The other end of the drill attachment shaft has a gear wheel on its internal end 102 that engages a circular ban 104 and forms the previously mentioned gear assembly. In FIG. 1, the ban 104 has an outer edge surface with teeth. The ban also has a bottom surface. At least a portion of the bottom surface can comprise teeth. The teeth on both surfaces are to engage the drill attachment to form the gear assembly for the purpose of transferring the force from a power source to the ban to rotate the ban. Having teeth on both surfaces enables the implementation of multiple gear configurations for the present invention. The ban 104 also has a top surface and an inner wall surface. The inner surface 80 has attached to it multiple bristles 90 for contacting the outer surface of a pipe for the purpose of scraping, shaving or cleaning the pipe surface. Steel crimped wire can comprise the material of the bristles. The bristles can be detachable from the inner wall of the ban. Below the bottom surface of the ban is an assembly to facilitate efficient rotation of the ban during operations. The assembly comprises a plurality of ball bearings 35 positioned between a top tray cover 30 and a bottom tray cover 40. The top tray cover 30 has a top surface and a sidewall extending downward from the entire top surface. The top surface and sidewall form the trough. Similar to the top tray cover, the bottom tray cover has a bottom surface and a sidewall 45 extending upward from the bottom surface. The tray design for the top and bottom covers create a trough in which the ball bearings will spin to facilitate the rotation of the ban. The top surface of the top tray cover attaches to the ban 104. The embodiment of the present invention shows the actual ban 104, gear assembly 20 and 25, the drill shaft 20 and the ball bearing assembly 35 enclosed in an outer cover 60. This outer cover can have a top section and a bottom section. The bottom tray of the ball bearing assembly can follow a track or groove in the bottom section of the outer cover 60 during the rotation of the ban and ball bearing assembly. In addition, the top side of the tray can have teeth that will engage the bottom side of the circular ban so that the ball bearing assembly can more easily rotate during tool operations. As shown in FIG. 3, the cover design tracks the internal shape of the device.

Entry of a pipe object into the device of the present invention can be from the top of the device or the front of the device. For purposes of a top-entry approach, the outer cover of the device can be in two parts. There can be a top cover that would fit over the top of the device of the present invention. The device could sit in the bottom cover. The top and bottom covers would be symmetrical and could be snapped together to seal them and secure the inner components of the device. The top and bottom cover have a front cover side 50. On this back cover side, there can be a hinge means attached to both the top and bottom covers. This hinge means can serve to facilitate opening and detaching of the top and bottom covers from each other. The hinge would enable one to pull up the top cover to open up the device and gain access to the components in the device.

In one embodiment, access to the inner components of the device of the present invention will be necessary in order to modify the device the device to accommodate pipes of various size external diameters. In this embodiment, exchangeable bans of various sizes can fit into the device assembly for pipes of different sizes. Each ban would be designed for a particular size pipe. The ban would contain bristles of various lengths for the different pipe sizes. For example, for a one-half inch diameter pipe, the bristles would fit in the ban such that the ends of the bristles would form a circular opening slightly smaller than one-half inch. When a one-half inch is inserted into the opening formed by the ends of the bristles, the bristles would be in firm contact with the outer surface of the pipe. Once the rotation of the ban begins, the bristles would scrape and clean the pipe desired. Because of the opening throughout the top and bottom of the tool, a user can move the pipe back and forth through the opening scraping and cleaning the outer surface of a pipe. When the user has finished with this pipe, the user could open the device and exchange the one-half inch ban with a ban for one inch to accommodate a pipe with a one-inch outer diameter. Even though the outer circumference of the ban would basically remain the same for purposes of the gear assembly, the length of the bristles extending inward would determine the size of pipe a ban could accommodate. This embodiment provides a straightforward way to insert and the remove pipe from the device of the present invention.

FIG. 3 shows an embodiment of the present invention having a front entry concept. In this embodiment, the front end of the cover housing can contract thereby creating an opening through which one can insert a pipe object into the device of the present invention. The housing can be comprised of the outer exterior wall and an inner wall. These walls form a channel and would enable a portion of the front end of the housing to slide back and forth to open and close the front entry opening. In this design, one segment of the from housing could move forming the opening. In the alternative, two sections could slide apart and create the opening. The sliding motion is facilitated by a pair of magnets 90 and 96 positioned at the upper and lower ends of the front of the housing. The front portions of the housing travel back and forth on a groove path to open and close the front entry opening. In addition to the housing having the capability to open, the ban with the cleaning bristles can also open on the front end to receive a pipe object for cleaning. When the housing and ban are open, the pipe object is inserted through the opening. Once the pipe is secured in the device, the magnets 90 and 96 come together to close and seal the opening.

This embodiment requires the device have the capability for the edges of the housing to slide back and forth to create a front-end entry point. An alternate embodiment of the present invention is to have a permanent front-end opening. In this embodiment, the front ends of the housing would not retract but would remain in a fixed position. This embodiment would have a latch type cover piece secured to the housing that would fit over and cover the opening between the front ends. Once a pipe was loaded into the device, the latch would attach to housing and fit over the opening to secure the pipe in the tool for the cleaning, shaving or scraping process. The latch cover could be completely detachable and attachable. In the alternative, the latch cover can be attached to one end of the housing and fold over the opening to cover the opening.

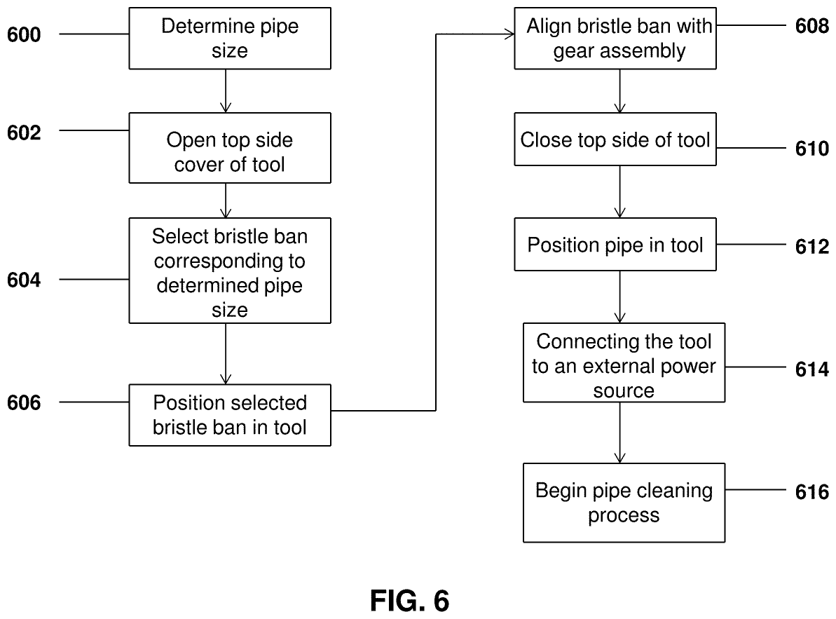

FIG. 6 shows a flow diagram of the method for implementing the tool of the present invention for shaving, scraping or cleaning a pipe. This method describes an application for the embodiment in which the top cover of the tool is detached or swung open to open up the tool. In this method, the initial step 600 is to determine the size of the pipe on which one wants to work. Size in this application refers to the external diameter of the pipe. External diameters can range for example from one-half inch to one and one-half inch. Any technique for measuring the pipe size will be sufficient. After one determines the pipe size, step 602 opens the topside cover of the tool. As mentioned, one can completely detach the topside cover. This cover can have means to snap the cover back in place as desired. In alternate approach can have the topside cover attached to the bottom side cover with a hinge means. In this approach, the topside cover would swing open via the hinge. With either approach, the topside cover could snap back in place. Once the topside is opened, step 604 selects a bristle ban that corresponds to the size of the measured pipe. When positioned in a circular shape, the endpoints of the bristles form a hollow circle slightly smaller than the outer diameter of the measured pipe. The smaller diameter formed by the bristles will facilitate efficient scraping, shaving or cleaning of the external pipe surface. Step 606 positions the selected bristle ban in the tool. In some embodiments, this step would involve placing the ban in a track of a gear tray. This tray's outer surface has gear teeth that would engage with the other gear and drill shaft that are part of the gear assembly. A track or threads in the gear tray can help tighten and secure the ban in the gear tray. In other situations, the positioning process may require the need to align the bristle ban with the gear assembly. This process would occur in step 608. Some ban designs have teeth on the outer side of the ban that engages the gear assembly. Other ban designs have teeth on the bottom edge of the ban to engage a gear assembly. Once the selected ban is positioned in and secured to the tool, step 610 closes the topside of the tool by re-attaching or closing the topside cover on the tool. In step 612, the pipe to be worked on is placed in the tool. In this method, there is a top end insertion of the pipe into the tool. The insertion would be through the opening extending throughout the tool. At this point, step 614 connects the tool to a power source. A, the power source would be a power tool such as a power drill. The end of the drill shaft not engaged with the tool would engage the power source. Step 616 begins the shaving, scraping or cleaning process on the pipe. In this process, the power supply turns the drill shaft. As the drill shaft rotates and turns the gear at the end of the shaft that is engaged with the gear. This rotating action causes the ban to rotate thereby causing the bristles in contact with the pipe surface to rotate. As the bristles rotate along the surface of the pipe, the bristles scrape, shave or clean the surface of the pipe. The user can move the tool back and forth along the surface of the pipe as part of the process. At the completion, the user will retract the pipe through the tool opening to remove the pipe from the tool.

The method, system and device for shaving, scarping or cleaning pipes of the present invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

I claim:

1. A portable tool for cleaning an outer surface of a pipe object comprising:
a drill shaft having a back end of the shaft adaptable for connecting to a power to supply power to the portable pipe cleaning tool and having a front end adapted to facilitate a circular rotation force for operation of the portable pipe cleaning tool;
a circular detachable ban having a top side, a bottom side, an outer wall and an inner wall, said ban forming an open space by its inner wall; and
a plurality of bristles attached to the inner wall of said ban, said bristles extending into the open space in the ban in order to contact an outer surface of a pipe object in order to clean the pipe surface as desired.

2. The portable pipe cleaning tool as described in claim 1 wherein said drill shaft further comprises a gear wheel attached to the front end of the shaft to form part of a gear assembly contained in the portable cleaning tool.

3. The portable pipe cleaning tool as described in claim 2 wherein said circular ban's bottom side further comprises a plurality of teeth such that said circular ban forms a gear wheel that engages with the gear wheel attached to said drive shaft whereby said circular ban gear wheel and said drive shaft gear wheel form a gear assembly in the portable cleaning tool.

4. The portable pipe cleaning tool as described in claim 3 further comprising a ball bearing assembly attached to the bottom side of said circular ban, the ball bearing assembly comprising a top tray cover, a bottom tray cover and a plurality of ball bearings positioned between the top and bottom tray covers.

5. The portable pipe cleaning tool as described in claim 2 wherein said circular ban's outer wall further comprises a plurality of teeth as part of a gear assembly.

6. The portable pipe cleaning tool as described in claim 4 further comprising an outer housing cover for the tool, the outer tool housing comprising a top section and a bottom section, said outer tool housing having a generally round shape with a linear neck portion housing the drill shaft and said housing having an opening consistent with the opening space of the circular ban.

7. The portable pipe cleaning tool as described in claim 6 wherein said the top section of said outer housing cover completely detaches from the bottom section.

8. The portable pipe cleaning tool as described in claim 6 further comprising a hinge means connected to the a front end of the top and bottom sections of the outer housing, said hinge means providing the capability for the top section to rotatably detach from bottom section and thereby open the portable pipe cleaning tool.

9. The portable pipe cleaning tool as described in claim 4 further comprising an outer housing cover for the tool, the outer tool housing comprising a top section and a bottom section, said outer tool housing having a generally round shape with a linear neck portion housing the drill shaft and said housing having an opening consistent with the opening space of the circular ban, said housing also having a front end section that is slidably connected and has the capability to slide back and forth to create an opening in the front end of the housing.

10. The portable pipe cleaning tool as described in claim 9 wherein the outer housing cover further comprises an outer exterior wall and an inner wall whereby these walls form a channel enabling the slidable front end section to move back and forth to create an opening in the housing for front end entry of a pipe.

11. The portable pipe cleaning tool as described in claim 10 wherein the slidable front end section further comprises two slidable sections both capable of moving back and forth to open and close the front end section of the housing, said both slidable sections having attached magnets to facilitate opening and closing of the front end section of the housing.

12. The portable pipe cleaning tool as described in claim 4 further comprising an outer housing cover for the tool, the outer tool housing comprising:
a top section and a bottom section, said outer tool housing having a generally round shape with a linear neck portion housing the drill shaft and said housing having an opening consistent with the opening space of the circular ban, and wherein said front end of the outer tool housing comprises an opening for end insertion of a pipe into the portable pipe cleaning tool; and
a latch element rotatably connected to the outer housing such that the latch element covers the opening in the front end of the housing, said latch element capable of rotating up to open the housing and rotating downward to close the housing and seal a pipe element inside the tool.

13. A portable system for cleaning an outer surface of a pipe object comprising:
a drill shaft having a back end of the shaft adaptable for connecting to a power to supply power to the portable pipe cleaning tool and having a front end adapted to facilitate a circular rotation force for operation of the portable pipe cleaning tool;
multiple circular detachable bans having a top side, a bottom side, an outer wall and an inner wall, said ban forming an open space by its inner wall; and wherein a specific ban is used with pipe of a specific outer circumference.
a plurality of bristles attached to the inner wall of said ban, said bristles extending into the open space in the ban in order to contact an outer surface of a pipe object in order to clean the pipe surface as desired.

14. The portable pipe cleaning system as described in claim 13 wherein each of said multiple bans further comprise bristles of a specific length that extend into the open space and form inner opening of a specific circumference size to accommodate pipes with that specific outer circumference size.

15. A method for cleaning an outer surface of a pipe object using a portable pipe cleaning device comprising:
determining an outer surface circumference for a pipe member;
selecting a ban with bristles of a length such that end tips of the bristles for a circular opening with a circumference of corresponding to the determined circumference of the pipe such that when the pipe is inserted through the circular opening formed by the bristles, bristle end tips are in contact with the outer surface circumference of the pipe;
positioning the selected ban in a portable pipe cleaning device;
inserting the member into the portable pipe cleaning device such that bristle end tips are in contact with the outer surface circumference of the pipe;
connecting the pipe cleaning device to a power source; and
applying power to the pipe cleaning device to initiate pipe cleaning activity.

16. The method as described in claim 15 wherein said inserting member step further comprises:
retracting a front end segment of a housing of the portable pipe cleaning device thereby creating an opening for insertion of a pipe element;
securing the pipe element in the pipe cleaning device between the bristles; and
reattaching a front end segment of housing, thereby closing the created opening and securing the pipe element inside the pipe cleaning device.

17. The method as described in claim 15 wherein said ban positioning step further comprising:
opening a top side cover of the pipe cleaning device;
positioning and securing the ban in the pipe cleaning device such that the ban is aligned with a gear assembly in the pipe cleaning device; and
closing the top side cover of the pipe cleaning device.

18. The method as described in claim 17 wherein said inserting member step further comprises inserting a pipe element into the pipe cleaning device through an opening formed in the top of the device and through the opening formed in the ban.

19. The method as described in claim 15 wherein said inserting member step further comprises:
disengaging and rotating a latch member attached to a front end section of an outer tool housing for the pipe cleaning device and thereby exposing an opening in the front end section of the housing;
inserting a pipe element into the pipe cleaning device through the front end opening; and
closing the front end opening by reattaching the latch member to the front end section of the tool housing and thereby securing the pipe in the housing.
